(19) United States
(12) Patent Application Publication
(10) Pub. No.: US 2009/0310030 A1
(43) Pub. Date: Dec. 17, 2009

(54) Using a Global Positioning System for Transmitter Identification in Mobile Television

(75) Inventors: Louis Robert Litwin, Edison, NJ (US); Eric Andrew Dorsey, Palo Alto, CA (US); Padmanabha R. Rao, Palo Alto, CA (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 11/922,114

(22) PCT Filed: Jun. 16, 2005
(86) PCT No.: PCT/US2005/021514

§ 371 Date: Dec. 13, 2007

(51) Int. Cl. H04N 5/50; G01S 1/00

(52) U.S. Cl. 348/731; 342/357.06; 348/E05.097

(57) ABSTRACT

A mobile digital TV (DTV) comprises a DTV receiver, a processor, a Global Positioning System (GPS) receiver and a memory for storing a data base of transmitter frequencies and transmitter locations for particular channels. The GPS receiver provides a location for the mobile DTV to the processor. The processor monitors distances between the location of the mobile DTV and at least two of the transmitter locations for a currently selected channel. Upon detecting that the mobile DTV is closer to a particular transmitting location than the other, the processor re-tunes the mobile DTV to the transmitter frequency of the closest transmitting for the currently selected channel.

### BACKGROUND OF THE INVENTION

The present invention generally relates to communications systems and, more particularly, to a mobile, or portable, device.

Mobile Television (TV) devices can be used in cars and trains which travel at a high speed. In some countries, such as the United Kingdom, a given channel may be transmitted on different radio frequencies (RFs) from different transmitter towers, each tower covering a different broadcast area. As such, as the user moves from one broadcast area to the next, the user can continue to watch the same show, or program, on a given channel (e.g., channel 3) by manually re-tuning the mobile TV as soon as the user perceives the signal to fade. Indeed, U.S. Patent Application No. 2004/0198217 published Oct. 7, 2004, describes a “follow-me” broadcast reception method and system that automatically re-tunes a mobile device upon detection of signal fading. In particular, the mobile device includes a Global Position System (GPS) receiver for providing a location of the mobile device. Upon detecting a signal fade, the mobile device sends the mobile device location to a “follow-me broadcast server”, which responds to the mobile device with new tuning information that is based on the location of the mobile device. The mobile device then re-tunes the receiver in accordance with the new tuning information.

### SUMMARY OF THE INVENTION

We have observed that the above-described techniques for manually re-tuning or automatically re-tuning a mobile, or portable, device do not completely address the problem. In each case, the signal must first fade before re-tuning the mobile device. As such, the user may experience interference and then an actual interruption in service for an extended period of time. For example, for manual re-tuning the length of time may be on the order of 10 seconds from detecting the fade to switching to a new transmitter frequency. This can be annoying and frustrating to the user who is simply trying to enjoy a program.

Therefore, and in accordance with the principles of the invention, a device comprises a GPS receiver for providing a location for the device, and a processor for initiating re-tuning of the device as a function of distance between the location of the device and a location associated with a transmitter. Thus, the device can re-tune before the user perceives any signal fade and the duration of any service interruption is reduced.

In an embodiment of the invention, the device is a mobile digital TV (DTV), which comprises a DTV receiver, a processor, a GPS receiver and a memory for storing a data base of transmitter frequencies and transmitter locations for particular channels. The GPS receiver provides a location for the mobile DTV to the processor. The processor monitors distances between the location of the mobile DTV and at least two of the transmitter locations for a currently selected channel. Upon detecting that the mobile DTV is closer to a particular transmitter than the other, the processor re-tunes the mobile DTV to the transmitter frequency of the closest transmitter for the currently selected channel.

### BRIEF DESCRIPTION OF THE DRAWINGS

FIG. 1 shows an illustrative device embodying the principles of the invention;

FIG. 2 shows an illustrative portion of a data base for use in the device of FIG. 1;

FIG. 3 shows an illustrative flow chart in accordance with the principles of the invention;

FIGS. 4 and 5 are used in conjunction with the description of the flow chart shown in FIG. 3;

FIG. 6 shows another illustrative portion of a data base for use in the device of FIG. 1;

FIG. 7 shows another illustrative flow chart in accordance with the principles of the invention; and

FIG. 8 shows an illustrative front view of an illustrative device embodying the principles of the invention.

### DETAILED DESCRIPTION

Other than the inventive concept, the elements shown in the figures are well known and will not be described in detail. Also, familiarity with digital television-based systems is assumed and is not described in detail herein. For example, other than the inventive concept, digital-TV bearing modulated signals, symbol constellations, carrier recovery, interpolation, phase-locked loops (PLLs), a radio-frequency (rf) front-end, or receiver section, such as a low noise block downconverter, formatting and encoding methods (such as Moving Picture Expert Group (MPEG)-2 Systems Standard (ISO/IEC 13818-1)) for generating transport bit streams, decoding methods such as log-likelihood ratios, soft-input-soft-output (SISO) decoders, Viterbi decoders, stored-program controlled processors, global positioning systems, and buttons for providing a user interface, are well-known and not described herein. In addition, the inventive concept may be implemented using conventional programming techniques, which, as such, will not be described herein. Finally, like-numbers on the figures represent similar elements.

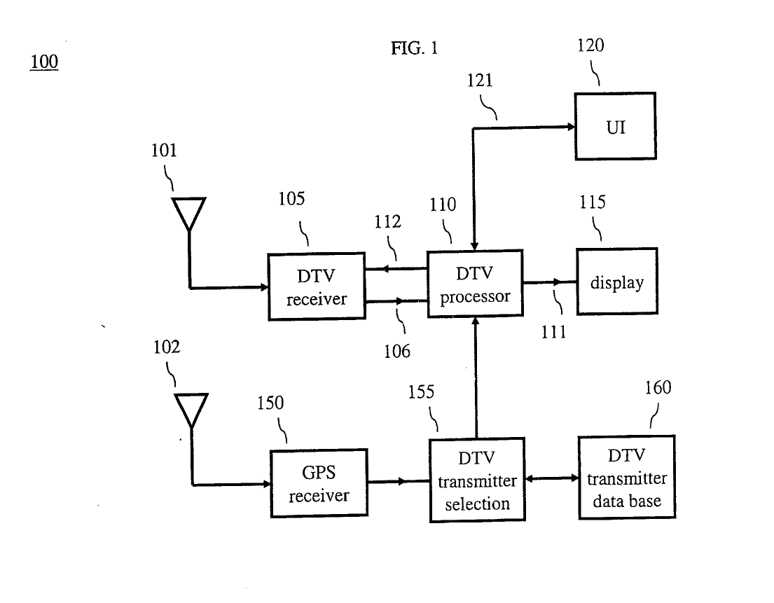

An illustrative device, mobile digital TV (DTV) 100, in accordance with the principles of the invention is shown in FIG. 1. Although the inventive concept is described in the context of a mobile DTV, the inventive concept is not so limited. Mobile DTV 100 comprises antennas 101 and 102, DTV receiver 105, DTV processor 110, display 115, user interface (UI) 120, GPS receiver 150, DTV transmitter selection element 155 and DTV transmitter data base 160. Illustratively, mobile DTV 100 conforms to the Digital Video Broadcasting (DVB-T and/or DVB-H) Standards found in Europe (e.g., see DVB Document No. A081, June 2004; ETSI EN 300 744 and other associated documents). In this regard, DTV receiver 105 receives a DTV signal, via antenna 101. DTV receiver 105 processes the received signal to provide a down-converted signal 106 to DTV processor 110. The latter further processes the down-converted signal to recover therefrom a digital service such as a digital video signal 111 for application to display 115 for viewing thereon by a user. Mobile DTV 100 is controlled by UI 120, via signaling path 121. UI 120 comprises a button arrangement and may be a physical part of mobile DTV 100 or a remote control. As such, UI 120 provides the ability for a user to, e.g., turn-on and off the device, select channels, adjust volume, traverse a graphical user interface (GUI) as represented by an electronic program guide (EPG) and/or a menu (such as for setting DTV parameters (e.g., video, audio, etc.)) presented on display 115 and provide interactive application data, etc. With regard to interactive application data, DTV processor 110 includes a memory (not shown) for storing therein an interactive application program downloaded via DTV receiver 105. Upon execution by DTV processor 110, the interactive application program provides an interactive application to the user. Known interactive applications are, e.g., weather, news, traffic and games (e.g., Tetris). An interactive application may be associated with a specific channel (e.g., a game channel) or with a program that is currently being viewed. For example, a sports program may also display a colored function key on the screen that, when selected by the user via UI 120, provides, e.g., additional team information. It should be noted that DTV processor 110 is representative of a processing function and may be implemented in one, or more, stored-program controlled processors (e.g., a microprocessor).

Turning now to the other portions of mobile DTV 100, GPS receiver 150 receives a GPS signal from antenna 102 and provides location information for Mobile DTV 100 to DTV transmitter selection element 150. The latter may be a part of one, or more, stored-program controlled processors (e.g., a microprocessor) such as represented by DTV processor 110. As described herein, location information for mobile DTV 100 and the transmitter can be in any form, so long as the location information can be used to determine the distance between mobile DTV 100 and the transmitters. Illustratively, it is assumed that location information described herein is representative of longitude, latitude and altitude. Further, it is assumed that a transmitter location is associated with a transmitter tower, but the invention is not so limited and transmitters may be associated with other locations. In accordance with the principles of the invention, DTV transmitter selection element 155 compares the location of mobile DTV 100 to data contained in DTV transmitter data base 160 for selecting a DTV transmitter with respect to the currently selected channel being viewed by the user (described further below). The selected transmitter, e.g., frequency information representative thereof, is provided to DTV processor 110 for re-tuning, if necessary, DTV receiver 105, via signal 112.

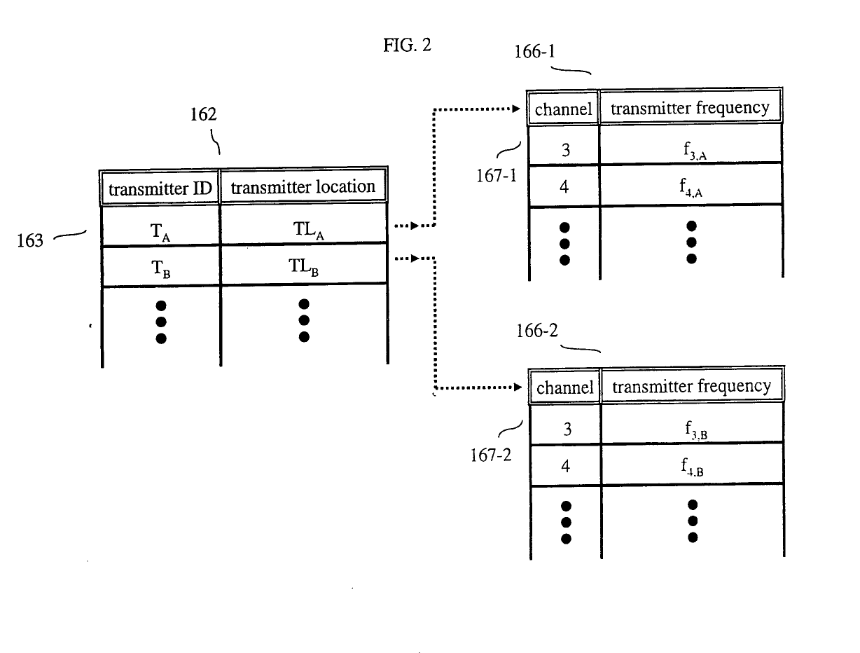

As noted above, DTV transmitter data base 160 provides data for selecting a DTV transmitter and is representative of a storage element, e.g., a memory, which can be volatile or non-volatile, for storing data. As used herein the term data base means any collection of information. As such, any form of data structure can be used in DTV transmitter data base 160 for storing transmitter information, e.g., flat files, linked lists, etc. An example of DTV transmitter data base 160 is shown in FIG. 2. DTV transmitter data base 160 comprises a number of tables as represented by tables 162, 166-1 and 166-2. Table 162 stores transmitter information for a number of transmitter towers. For each transmitter tower there is a transmitter identification (ID) and the associated location of the transmitter tower. For example, as shown in row 163 of table 162, a transmitter tower, T_{A}, has a location TL_{A}. In addition, for each transmitter tower there is an associated table of channels and frequency assignments. This is illustrated in FIG. 2 for transmitter towers T_{A} and T_{B}, for which there are associated tables 166-1 and 166-2, respectively. As illustrated by row 167-1 of table 166-1, channel 3 is transmitted at a frequency of f_{3,A} for tower T_{A}. Likewise, as illustrated by row 167-2 of table 166-2, channel 3 is transmitted at a frequency of f_{3,B} for tower T_{B}. The information represented in DTV transmitter data base 160 can be created in any number of ways. For example, DTV transmitter data base 160 can be pre-programmed into mobile DTV 100, or the information can be downloaded as a part of a service information table in the above-mentioned DVB-T standard.

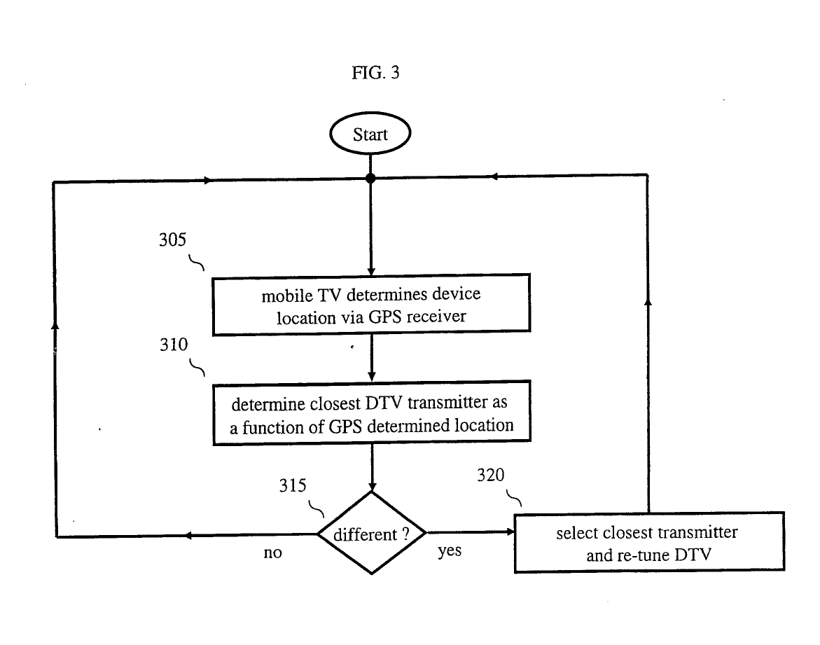

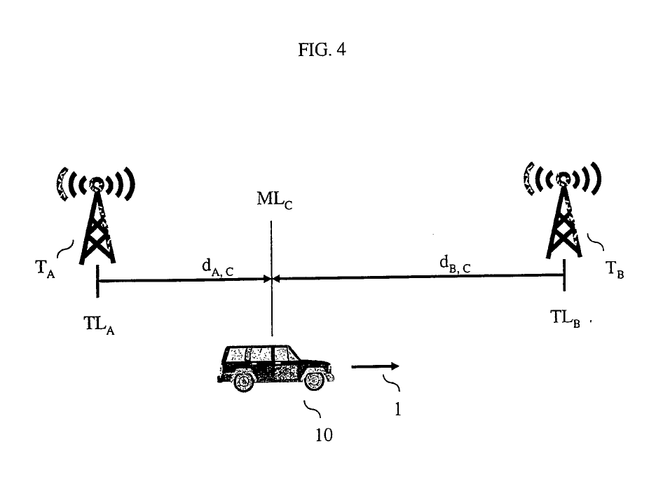

Referring now to FIG. 3, an illustrative flow chart for use in mobile DTV 100 in accordance with the principles of the invention is shown. In this example, it is assumed that a user has selected channel 3 for viewing, e.g., via the above-described UI 120. Turning briefly to FIG. 4, it is assumed that mobile DTV 100 is located in a vehicle 10 carrying the user and moving in a direction indicated by arrow 1. Vehicle 10, and therefore mobile DTV 100, has a location ML_{C}. This location information, i.e., the device location, is also provided to mobile DTV 100 via GPS receiver 150 of FIG. 1, as described above. As illustrated in FIG. 4, mobile DTV 100 is located between two broadcast areas. One broadcast area is served by transmission tower T_{A} (transmitter T_{A}), which has a location TL_{A} and the other broadcast area is served by transmitter T_{B}, which has a location TL_{B}. The distance between mobile DTV 100 and transmitter T_{A} is represented in FIG. 4 by d_{A,C}; while the distance between mobile DTV 100 and transmitter T_{B} is represented by d_{B,C}. Initially, it is assumed that mobile DTV 100 is closer to transmitter T_{A} (d_{A,C}<d_{B,C}) and DTV receiver 105 of FIG. 1 is tuned to a frequency of f_{3,A} for receiving channel 3 (Table 166-1 of FIG. 2). As such, the currently selected transmitter is T_{A}.

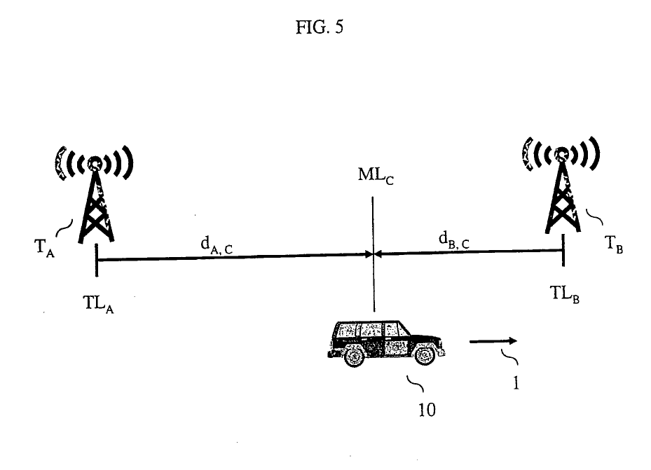

Returning to FIG. 3, mobile DTV 100 determines its location via GPS receiver 150 in step 305. In step 310, mobile DTV 100 (e.g., DTV transmitter selection element 155 of FIG. 1) determines which DTV transmitter from DTV transmitter data base 160 of FIG. 1 is the closest to the location of mobile DTV 100. Since, as illustrated in FIG. 4, transmitter T_{A} is the closest DTV transmitter, mobile DTV 100 selects transmitter T_{A}. In step 315, mobile DTV 100 determines if the closest DTV transmitter is different from the currently selected transmitter. Since the currently selected transmitter is transmitter T_{A} and transmitter T_{A} is also the closest DTV transmitter, mobile DTV 100 returns to step 305 and repeats the process. However, at a later point in time, the above-described process determines in step 310 that transmitter T_{B} is now closer than transmitter T_{A}. This is illustrated in FIG. 5, where vehicle 10 has continued to move in the direction of arrow 1 such that d_{A,C}>d_{B,C}. As such, in step 315 of FIG. 3, mobile DTV 100 determines that the closest DTV transmitter, T_{B}, is now different from the currently selected transmitter, T_{A}. In this case, mobile DTV 100 selects transmitter T_{B} as the currently selected transmitter and re-tunes DTV receiver 105 of FIG. 1 to a frequency of f_{3,B}. to continue to receive channel 3 (Table 166-2 of FIG. 2). Thus, and in accordance with the principles of the invention, as the user watches a program on channel 3, mobile DTV 100 continues to re-tune, or hand-off, to the closest transmitter as mobile DTV 100 moves through and between different broadcast areas. This reduces, if not eliminates, any interruption in service since mobile DTV 100 does not wait for the signal to fade before looking for a new transmitter.

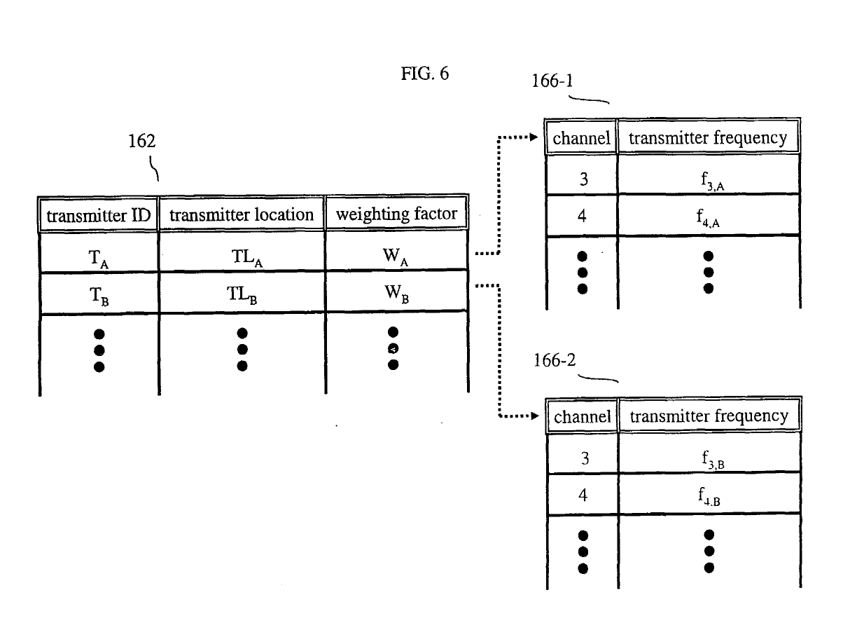

It should be noted that other variations are possible. For example, other transmitter parameters can be considered in determining which is the closest transmitter. As illustration of one such parameter, consider the broadcast power of a transmitter. It transmitter towers can have different broadcast powers then data representative of the broadcast power can be added to data base 160 of FIG. 1 and the determination of the closest transmitter can also take into account broadcast power. For example, if, in FIG. 4, transmitter T_{A} broadcasts a signal at a higher power than transmitter T_{B}, then mobile DTV 100 may still be able to effectively receive a signal from transmitter T_{A} even when transmitter T_{B} is determined to be the closest transmitter. In this regard, data base 160 may include a weighting factor for each transmitter tower, where the weighting factor is used to adjust the actual distance of the transmitter tower from mobile DTV 100 into an effective distance and step 310 of FIG. 3 is modified such that the transmitter closest, in terms of effective distance, is selected as the closest transmitter. Such an illustrative data base is shown in FIG. 6. In simplest form, an effective distance is equal to an actual distance multiplied by a weighting factor. In addition, the location of the device may be used to implement different algorithms for selecting the closest transmitter. For example, if mobile DTV 100 is located at a location F, then actual distances are used to determine the closest transmitter, however if mobile DTV 100 is located at a location H, then the above-mentioned effective distance is used to determine the closest transmitter. Also, it should be noted that the flow chart of FIG. 3 can be performed continuously, periodically, e.g., every second, or as a function of distance moved in a period of time (which can be determined from the device location provided by GPS receiver 150 of FIG. 1).

As another alternative, consider the following. Experimental measurements are taken with respect to each transmitter tower for determining coverage areas for each transmitter and/or switching locations at which to switch from one broadcast tower to another. In this context, data base 160 is modified to include the coverage area data and/or switching locations for each transmitter. Decisions to re-tune the device as a function of distance between the location of the device and a transmitter tower location are then based on either the location of the device within a coverage area and/or the proximity to a switching location.

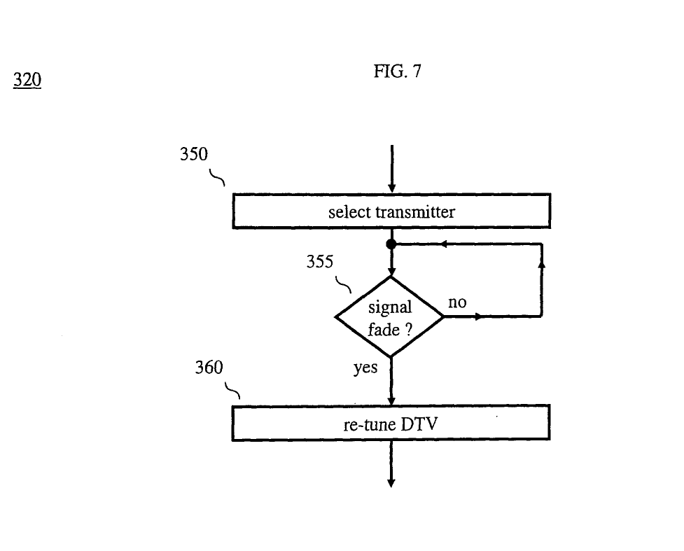

In accordance with another feature of the invention, step 320 of FIG. 3 can be further modified as shown in FIG. 7. In step 350, the transmitter is selected as described above, i.e., the frequency for re-tuning the transmitter is determined for the currently selected channel. However, in step 355, mobile DTV 100 waits for the signal to fade. Upon detecting a signal fade, e.g., a received signal strength indicator (RSSI) (not shown) provided by DTV receiver 150 is less then an RSSI threshold, e.g., 18 dB, Mobile DTV 100 is re-tuned in step 360.

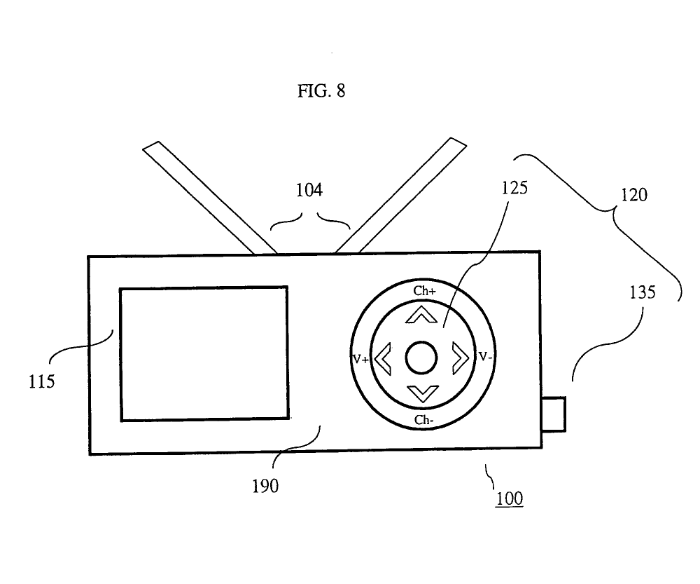

Turning now to FIG. 8, an illustrative front view of mobile DTV 100 is shown. It should be noted that this view is only illustrative, is not to scale, and is merely used to highlight a device incorporating the principles of the invention. Mobile DTV 100 is a portable device that is contained within a housing 190. As can be observed from FIG. 8, housing 190 provides support for display 115, user interface 120 and antenna 104. In this illustration, antenna 104 represents the above-mentioned antennas 101 and 102. User interface 120 comprises at least a navigational button arrangement 125 and other buttons as represented by button 135. Although not necessary for the inventive concept, button arrangement 125 illustratively provides the ability for a user to change channels and adjust volume, etc. This is shown in FIG. 8 by the illustrative use of the labels “Ch+” and “Ch−” as indicating the buttons used for incrementing and decrementing a current channel selection; and by the illustrative use of the labels “V+” and “V−” as indicating the buttons used for increasing and decreasing a current volume setting. Likewise, other buttons may be present, e.g., a power button, as represented by button 135, but these are also not relative to the inventive concept.

As described above, and in accordance with the principles of the invention, a device comprises a GPS receiver for providing a location for the device, and a processor that initiates re-tuning of the device as a function of distance between the location of the device and a transmitter tower location. Thus, the device can re-tune before the user perceives any signal fade and the duration of any service interruption is reduced. Although illustrated in the context of a mobile TV, the inventive concept is not so limited and is applicable to any device, mobile, portable or otherwise. For example, the inventive concept is applicable to a device that may not be considered portable but is mobile, e.g., mounted within a vehicle such as a car, train or plane. In addition, although illustrated in the context of a GPS receiver, any mechanism can be used in the device for receiving location information. For example, the device can compute a relative distance from transmitter towers by estimating the distance as a function of received signal power at the different frequencies.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs). Similarly, although shown as separate elements, any or all of the elements of may be implemented in a stored-program-controlled processor, e.g., a digital signal processor, which executes associated software, e.g., corresponding to one or more of the steps shown in, e.g., FIG. 3. It is therefore to be understood that numerous modifications may be made to the illustrative embodiments and that other arrangements may be devised without departing from the spirit and scope of the present invention as defined by the appended claims.

1. Apparatus for use in a device, which is capable of being tuned to receive information, the apparatus comprising:
a receiver for providing information for use in determining a location of the device; and
a processor for initiating re-tuning of the device as a function of distance between the location of the device and a location associated with a transmitter.

2. The apparatus of claim 1, wherein the receiver for providing information is a global positioning system (GPS) receiver.

3. The apparatus of claim 1, further comprising:
a digital television (DTV) receiver for tuning to one of a number of frequencies for receiving at least one program on a selected channel;
wherein the processor re-tunes the device by tuning the DTV receiver to one of the number of frequencies for the selected channel.

4. The apparatus of claim 1, further comprising:
a memory for storing transmitter information for a number of transmitters, wherein for each transmitter the memory stores at least an associated location and an associated transmitting frequency for use by the processor in re-tuning the device.

5. The apparatus of claim 1, wherein the distance is an actual distance.

6. The apparatus of claim 1, wherein the distance is an effective distance.

7. The apparatus of claim 1, wherein the location associated with a transmitter is a coverage area.

8. The apparatus of claim 1, wherein the location associated with a transmitter is a switching location.

9. The apparatus of claim 1, wherein the processor determines the distance periodically.

10. The apparatus of claim 1, wherein the processor re-tunes the device by determining tuning information for the DTV receiver and then waiting for a received signal to fade.

11. A method for use in a device, the method comprising:
receiving location information for the device; and
initiating re-tuning of the device as a function of distance between the location of the device and a location associated with a transmitter.

12. The method of claim 11, wherein the receiving step receives information from a global positioning system (GPS).

13. The method of claim 11, further comprising:
tuning a digital television (DTV) receiver to one of a number of frequencies for receiving at least one program on a selected channel; and
wherein the initiating step re-tunes the device by tuning the DTV receiver to one of the number of frequencies for the selected channel.

14. The method of claim 11, further comprising:
storing transmitter information for a number of transmitters, wherein for each transmitter the memory stores at least a transmitter location and an associated transmitting frequency for use in re-tuning the device.

15. The method of claim 11, wherein the distance is an actual distance.

16. The method of claim 11, wherein the distance is an effective distance.

17. The method of claim 11, wherein the location associated with a transmitter is a coverage area.

18. The method of claim 11, wherein the location associated with a transmitter is a switching location.

19. The method of claim 11, wherein the initiating step determines the distance periodically.

20. The method of claim 11, wherein the initiating step includes:
determining tuning information for the DTV receiver; and
waiting for a received signal to fade before re-tuning the device.

21. A method for use in a device, the method comprising:
receiving location information for the device;
receiving a program on a selected channel;
storing transmitter information, which comprises at least transmitter locations and transmitter frequencies associated with the selected channel; and
re-tuning the device for receiving the program by monitoring distances between the device and transmitter locations stored in the memory.

22. The method of claim 21, wherein the receiving location information step receives information from a global positioning system (GPS).

23. The method of claim 21, wherein the distance is an actual distance.

24. The method of claim 21, wherein the distance is an effective distance.

25. The method of claim 21, wherein the location associated with a transmitter is a coverage area.

26. The method of claim 21, wherein the location associated with a transmitter is a switching location.

27. The method of claim 21, wherein the re-tuning step determines the distance periodically.

28. The method of claim 21, wherein the re-tuning step includes the steps of:
selecting that transmitter location that is closest in distance to the device; and
re-tuning the device to the associated transmitter frequency for the selected channel.

29. The method of claim 21, wherein the re-tuning step includes:
determining tuning information for the DTV receiver; and
waiting for a received signal to fade before re-tuning the device.
